(19) United States
(12) Patent Application Publication
(10) Pub. No.: US 2024/0233145 A9
(43) Pub. Date: Jul. 11, 2024

(54) METHOD AND SYSTEM FOR DIFFERENTIATING QOS OF INTER-MICROSERVICE COMMUNICATION

(71) Applicant: Electronics and Telecommunications Research Institute, Daejeon (KR)

(72) Inventors: Ho Sub YOON, Daejeon (KR); Jae Hong KIM, Daejeon (KR); Jong Won MOON, Daejeon (KR); Jae Yoon JANG, Daejeon (KR)

(73) Assignee: Electronics and Telecommunications Research Institute, Daejeon (KR)

(21) Appl. No.: 18/490,386

(22) Filed: Oct. 19, 2023

(30) Foreign Application Priority Data
Oct. 21, 2022 (KR) 10-2022-0136795

(51) Int. Cl. G06T 7/292; G06V 10/74; G06V 10/774; G06V 10/80

(52) U.S. Cl. CPC G06T 7/292; G06V 10/761; G06V 10/774; G06V 10/80; G06T 2207/10016; G06T 2207/20081; G06T 2207/20221

(57) ABSTRACT

Provided are a device and method for tagging training data. The method includes detecting and tracking one or more objects included in a video using artificial intelligence (AI), when there is an object to be split in a result of tracking the detected objects, splitting the object in object units, and when there are identical objects to be merged among split objects, merging the objects.

### CROSS-REFERENCE TO RELATED APPLICATION

This application claims priority to and the benefit of Korean Patent Application No. 10-2022-0136795, filed on Oct. 21, 2022, the disclosure of which is incorporated herein by reference in its entirety.

### BACKGROUND

### 1. Field of the Invention

The present disclosure relates to a device and method for tagging a large amount of training data, and more specifically, to a training data tagging device and method for efficiently generating a large amount of training data required for deep learning for detecting, tracking, and reidentifying various objects present in a camera.

### 2. Discussion of Related Art

The major limitation for large information technology (IT) companies to introduce artificial intelligence (AI) technology is the lack of large amounts of training data. According to a survey by the Massachusetts Institute of Technology (MIT) Technology Review, 48% of global AI companies are having difficulty acquiring available data. Accordingly, competitiveness in AI technology development lies in acquiring training data. Even when an algorithm with excellent performance is employed, expected performance is not achieved in most cases due to insufficient data required for training a model.

Therefore, it is necessary first to acquire a large amount of training data in order to successfully implement an AI project. However, when the amount of training data increases, a required time and cost sharply increase. Therefore, it is not easy to acquire a large amount of training data.

### SUMMARY OF THE INVENTION

The present disclosure is directed to providing a training data tagging device and method for efficiently generating a large amount of training data required for deep learning for detecting, tracking, and reidentifying various objects present in a camera.

Technical objectives to be achieved in the present disclosure are not limited to that described above, and other technical objectives which have not been described will be clearly understood by those of ordinary skill in the art from the following descriptions.

According to an aspect of the present disclosure, there is provided a method of tagging training data, the method including detecting and tracking one or more objects included in a video using artificial intelligence (AI), when there is an object to be split in a result of tracking the detected objects, splitting the object in object units, and when there are identical objects to be merged among split objects, merging the objects.

The splitting of the object may include calculating a similarity difference between a first image and a last image of each of the detected objects in the result of tracking the detected objects and splitting the corresponding object when the calculated similarity difference is a preset value or less.

The splitting of the object may include, when the calculated similarity difference is the preset value or less, calculating a similarity between each of remaining images and the first image and a similarity between each of the remaining images and the last image, finding an image having a higher similarity with the last image than a similarity with the first image, and splitting the corresponding object.

The splitting of the object may include assigning new object identities (IDs) to images obtained by splitting the object.

The merging of the objects may include calculating a similarity between a representative image of any one of the split objects and a representative image of another one of the split objects and merging the latter object with the former object when the calculated similarity is a preset certain value or more.

The merging of the objects may include merging the latter object with the former object by changing an ID of the latter object to an object ID of the former object.

The merging of the objects may include, when object merging is performed at each of a plurality of cameras, merging objects merged at the plurality of cameras in an integrative manner.

Results of the detecting, the tracking, the splitting, and the merging may be generated and stored in preset file formats, and the detection result may include type information, (x, y) coordinate information, and width and height information of the one or more detected objects.

According to another aspect of the present disclosure, there is provided a device for tagging training data, the device including a tracker configured to detect and track one or more objects included in a video using AI, a splitter configured to perform object splitting in object units when there is an object to be split in a result of tracking the detected objects, and a merging part configured to perform object merging when there are identical objects to be merged among split objects.

The features of the present disclosure briefly summarized above are merely exemplary aspects of the detailed description of the present disclosure and do not limit the scope of the present disclosure.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is an operation flowchart illustrating a method of tagging training data according to an exemplary embodiment of the present disclosure;

FIG. 2 is a table showing an example of object detection results;

FIG. 3 is a table showing an example of object tracking results;

FIG. 4 is a set of images showing examples of a graphical user interface (GUI) for splitting and merging;

FIG. 5 is a set of images showing examples of a GUI for splitting;

FIG. 6 is a set of images showing examples of a GUI for merging;

FIG. 7 is an operation flowchart illustrating a process of reidentifying and tagging the same object which is input at different times to multiple cameras disposed at different locations according to an exemplary embodiment of the present disclosure;

FIG. 8 is a table showing an example of integration results among cameras;

FIG. 9 is a block diagram of a device for tagging training data according to another exemplary embodiment of the present disclosure; and

FIG. 10 is a block diagram of a device to which the device for tagging training data according to the other exemplary embodiment of the present disclosure is applied.

### DETAILED DESCRIPTION OF EXEMPLARY EMBODIMENTS

Hereinafter, exemplary embodiments of the present disclosure will be described in detail with reference to the accompanying drawings so that those of ordinary skill in the art may easily implement the present disclosure. However, the present disclosure may be implemented in a variety of different forms and is not limited to the exemplary embodiments described herein.

In describing the present disclosure, when it is determined that detailed description of a well-known element or function may obscure the gist of the present disclosure, the detailed description will be omitted. Throughout the drawings, parts irrelevant to description of the present disclosure will be omitted, and like reference numerals refer to like elements.

In this present disclosure, when a first component is described as being “connected,” “coupled,” or “linked” to a second component, the first component may be directly connected, coupled, or linked to the second component, or a third component may be present therebetween. Also, when a first component is described as “including” or “having” a second component, other components are not precluded, and a third component may be further included unless particularly described otherwise.

In the present disclosure, terms such as “first,” “second,” etc. may be only used for the purpose of distinguishing one component from another and do not limit the order, importance, etc. of components unless particularly described. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly illustrate each feature, but it does not necessarily mean that the components are separate. In other words, a plurality of components may be integrated into one hardware or software unit, or a single component may be distributed into a plurality of hardware or software units. Accordingly, unless otherwise noted, embodiments including such integrated or distributed components also fall within the scope of the present disclosure.

In the present disclosure, components described in various embodiments are not necessarily essential components, and some may be optional components. Accordingly, embodiments including a subset of components described in one embodiment also fall within the scope of the present disclosure. Also, embodiments that include other components in addition to components described in various embodiments also fall within the scope of the present disclosure.

In the present disclosure, expressions of positional relationships, such as top, bottom, left, right, and the like, are used for convenience of description, and when the drawings shown in this specification are viewed in reverse, the positional relationship described herein may be interpreted the other way around.

In the present disclosure, each of the phrases “A or B,” “at least one of A and B,” “A, B, or C,” and “at least one of A, B, and C” may include any one of items listed in the phrase or all possible combinations thereof.

In general, a company that handles videos or images tags each desired object in each video or image with a unique label to generate data for training. Such a task is defined as a tagging task. Tagging involves inputting unique label information to a target of identification in a video or image to facilitate training of a classification and clustering algorithm. Here, tagging a huge number of frames of a video one by one is very time-consuming and inefficient, thus imposing a major limitation on training data generation. When such a tagging task is automated, training data may be very easily generated, and thus it is being attempted to develop an automatic tagging platform that facilitates training data generation. A representative example of automatic tagging platforms is Chooch artificial intelligence (AI). This platform generates training data by automatically attaching a tag related to an appearing object and sound to each frame of a video or each image input through an application programming interface (API). This type of platform may efficiently generate high-quality training data which is necessary for AI technology development, and thus is frequently used for acquiring data.

However, a tagging tool employing an automatic AI algorithm developed to generate object (human) reidentification training data according to the related art makes many errors when people frequently overlap. Most of such errors require a review task of manually correcting automatic tagging results frame by frame. Accordingly, even in the case of tagging a short video of three minutes, when many objects (e.g., 20 or more people) are present in a screen, a manual auxiliary tagging task of at least four hours is necessary. As a result, such difficulty in tagging is considered a difficult problem in generating a large amount of training data which is necessary for human reidentification algorithm development.

To solve this problem, algorithms are lately being developed for AI to tag training data without human intervention. However, current results of tagging real videos or images other than simple videos or images by AI lack reliability, and thus the algorithms are not widely being used.

Exemplary embodiments of the present disclosure provide a method of labeling training data for object (human) detection and tracking using a previously developed AI technology and finally completing tagging of detection, tracking, and identification technology training data using a tool for a human labeler to perform object-oriented splitting and merging on data labeled by AI, to develop an object (human) detection, tracking, and identification technology requiring a large amount of training data among AI technologies.

When a method of generating object detection, tracking, and reidentification training data in such a manner is used, it is currently possible to save ten times or more the labeling time and resources of a case where a labeler (human) labels every frame of all data, and thus a large amount of data required for training can be collected economically. Also, when performance of object detection, tracking, and reidentification AI is continuously improved using a large amount of training data generated according to exemplary embodiments of the present disclosure, a time for a tagging task involving a labeler (human) can be sharply reduced.

Therefore, exemplary embodiments of the present disclosure relate to a method of remarkably lowering difficulty in manual tagging on the basis of results of tagging by AI. According to exemplary embodiments of the present disclosure, in the case of manual tagging, a labeler does not review all frames one by one. Rather, after tagging results which are generated by AI detecting and tracking each object (human) present throughout a video are stored as a file of a certain format, for example, a “.csv” file, a labeler may check detection and tracking information of each object by reading the stored “video.csv” file and then perform tagging by splitting and merging objects through simple mouse operations. Such a tagging method is 10 times or more as efficient as a method in which a labeler reviews all frames one by one according to the related art, and it is possible to rapidly acquire tagging results that are more available for training and more reliable than results of tagging by AI.

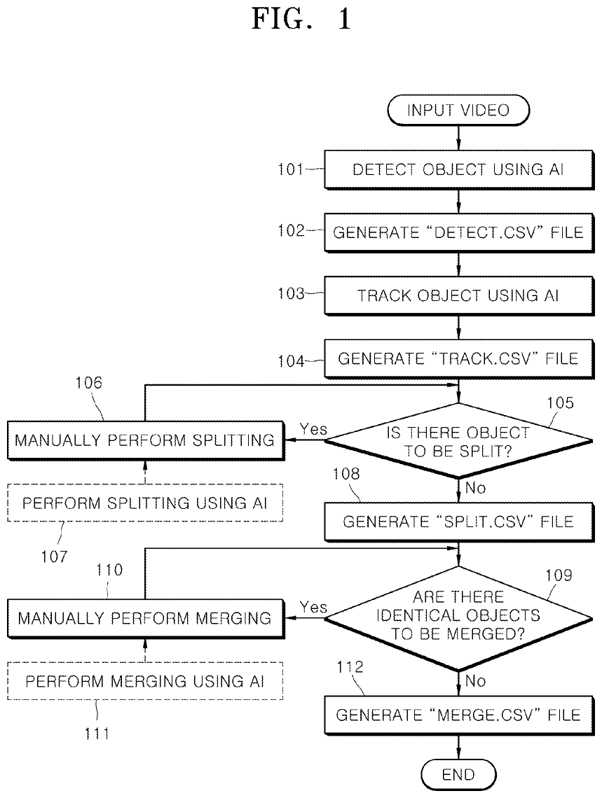

FIG. 1 is an operation flowchart illustrating a method of tagging training data according to an exemplary embodiment of the present disclosure.

Referring to FIG. 1, in the method of tagging training data according to the exemplary embodiment of the present disclosure, when a video is input, objects included in the video are detected using pretrained AI, and the object detection results are generated and stored in a preset file format (101 and 102).

Here, the video may be an input video file which is acquired from a camera and requires tagging. The video includes various objects and may be tagged with detection, tracking, and reidentification information of each object through the method of the present disclosure.

The AI for detecting objects in the operation 101 may be any one of various models of object detection algorithms based on deep learning technology including a residual neural network (ResNet), a region-based fully convolutional network (RFCN), densely connected convolutional networks (DenseNet), you only look once (YOLO), feature pyramid networks (FPN), a mask region-based convolutional neural network (RCNN), a RetinaNet, a complete and efficient graph neural network (ComeNet), and the like. For example, the AI for detecting objects may adopt a YOLO V.5 model among the above AI algorithms to detect objects in a video.

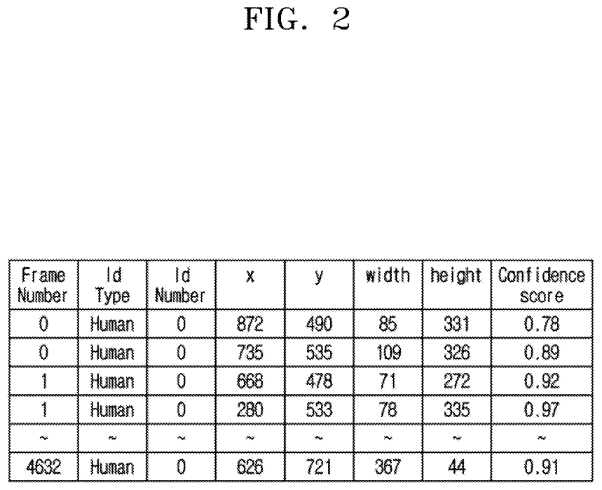

The object detection results acquired in the operation 101 may be generated and stored as a “detect.csv” file, and the generated “detect.csv” file may store various information as shown in the example of FIG. 2.

The frame number column of FIG. 2 shows IDs generated when a video is divided into frames. When the video is 10 seconds long and has 30 frames per second, IDs of 1 to 300 are generated. The ID type column may show types of objects to be tagged (e.g., person, car, bicycle, motorbike, and the like). The ID number column may show unique numbers assigned to objects present in each frame. However, the “detect.csv” file includes information on detected regions, but no IDs are assigned to the objects. Accordingly, IDs of all the objects may be set to 0. The x, y, width, and height columns show x and y positions, widths, and heights of the detected objects, and minimum bounding rectangles (MBRs) of the detected objects may be displayed using the information. Finally, the confidence score column may show reliability values of the objects detected by an AI detection module. A higher confidence score represents a higher probability that the corresponding object will be an actual object rather than noise.

When the “detect.csv” file is generated as shown in FIG. 2 using the object detection AI model, the detected objects are tracked on the basis of the input video and the object detection results, that is, the “detect.csv” file, and the object tracking results may be generated and stored in a preset file format (103 and 104).

In the operation 103, the objects stored in the “detect.csv” file may be tracked using an AI-based object tracking algorithm. The AI-based object tracking algorithm may be any one of DeepSort, AP-HWDPL, a recurrent autoregressive network (RAN), multiple hypothesis tracking (MHT) bidirectional long short-term memory (bLSTM), and the like. For example, the AI-based object tracking algorithm may be a DeepSort model and may generate and store object tracking results as a “track.csv” file.

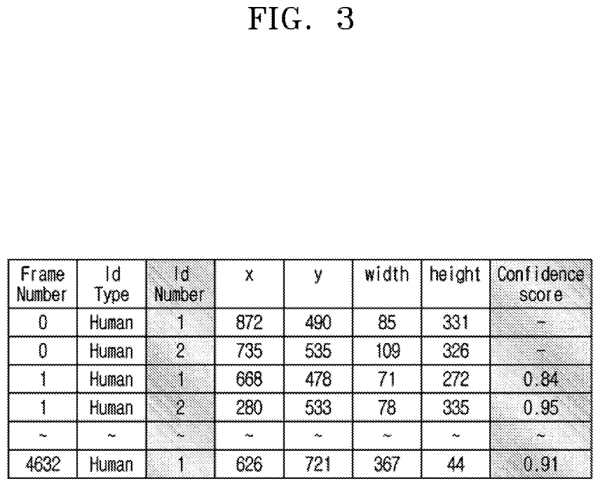

Here, the “track.csv” file may store various information as shown in the example of FIG. 3.

As shown in FIG. 3, the difference between the “track.csv” file and the “detect.csv” file lies in the ID number column. The AI-based object tracking algorithm, for example, the DeepSort model, tracks an object which is present in a previous frame using detected type and region information and assigns the same ID to the same object which is present in subsequent frames.

When tracking of the detected objects is finished through the operation 104, incorrectly tagged object IDs are split in object units rather than frame units through the previously processed “track.csv” file. When the splitting in object units is completed, object merging is performed on the basis of results of the splitting in object units to complete the process of tagging training data (105 to 112).

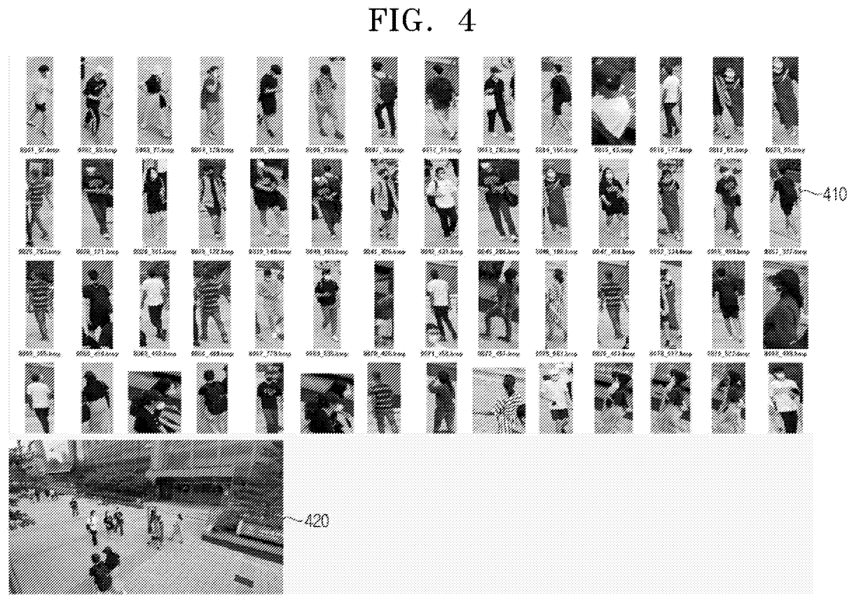

For example, FIG. 4 is a set of images showing examples of a graphical user interface (GUI) for splitting and merging. FIG. 4 shows a GUI and function of checking objects which are previously labeled by an AI model.

The GUI is not shown in FIG. 4 but provides an interface for selecting a video and the path of a comma-separated values (CSV) file. When a video and the path of a CSV file are selected through the interface and then an input on an execution button, for example, a “Go” button, is executed, the GUI outputs a representative image 410 for each of IDs which are present in the video. Here, the representative image of each ID may be represented as “ID number_representative frame number.bmp,” for example, “0014_155.bmp.” As the representative image of each ID, any one of an image in which the ID is shown for the first time, an image in which the ID is shown for the last time, and an image in which the ID is shown in between may be selected. FIG. 4 shows a case of selecting an image in which each ID is shown for the first time as the representative image of the ID, and each ID number represents overall information of a frame where each ID is shown for the first time to a frame where the ID is shown for the last time

Further, when a user or labeler selects a representative image (e.g., 410) of a specific ID and then selects a “Play” button (not shown) of a preview window 420, the GUI allows the user or labeler to check information of a start and end of a part of the video in which the selected ID is generated through outputs of MBRs having unique colors. In other words, frames having the same specific ID selected by the user or labeler are output through the preview window 420 and thus can be sequentially checked.

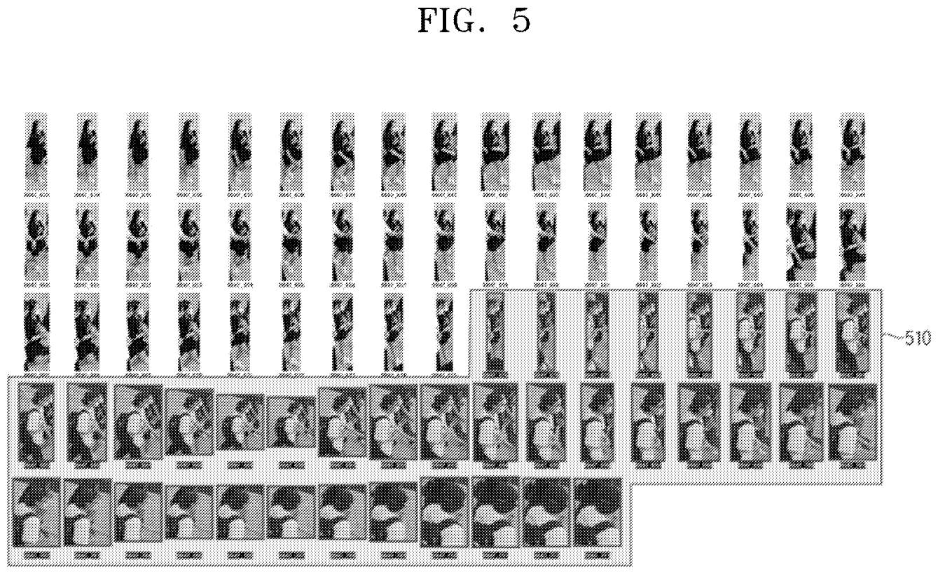

Subsequently, when each ID shown in FIG. 4 is selected with a certain number of clicks, for example two clicks, a split GUI may be provided as shown in FIG. 5. When the tracking model identifies different objects as one object due to overlap or noise, a split GUI function shown in FIG. 5 facilitates splitting of the objects. The split GUI of FIG. 5 sequentially shows a frame where an ID assigned to one object is generated for the first time to a frame where the ID is generated for the last time on a screen. A labeler may check these results and determine whether all frames include the same ID. When an additional object overlaps the object as shown in FIG. 5, the labeler may select a start and end of the overlapping part of the video through mouse clicks (510) and then select a “Split” button in the GUI to separate the additional object. Here, the additional object is automatically assigned a new ID, and changed information may be reflected on a “split.csv” file. This task may be performed for all IDs, and split tagging may be manually completed by the labeler.

Such a splitting task is not limited to being performed by a manual task of a user or labeler and may also be performed using pretrained AI. In this way, it is possible to efficiently reduce the number of IDs that require manual splitting. According to an AI technology for automatically performing a splitting task, a similarity difference may be calculated between a first image and a last image of each ID, and the ID may be determined to require splitting when the similarity difference is a small value of a certain value or less. While images are sequentially searched, frames' similarities with the first image and the last image may be measured, and a frame which has a higher similarity with the last image than with the first image may be found and determined to be a frame where automatic splitting will be started.

This may be expressed in a C++ algorithm as follows.
n = Id count;
i = Id number;
i.frame_start = frame count;
i.frame_end = frame count;
j = frame number;
For (i = 1, I < n, i++) {
If (similarity(i.frame_start, i.frame_end) < Threshold_value(0.7) {
For (j = z_start+1, j < z_end, j++)
If (similarity(j, z_start) < similarity(j, z_end) break;
i.split_point = j;
else
i.split_point = 0;
}

Here, n is the number of IDs that are present in one video, i is a value between 0 and n, i.frame_start is a frame number where the same ID is shown for the first time, i.frame_end is a frame number where the same ID is shown for the last time, and j is the number of frames from i.frame_start to i.frame_end.

In the above algorithm, similarity(i.frame_start, i.frame_end) is a function for calculating a similarity between an MBR image in a first frame (i.frame_start) where an i^{th} ID obtained by reading the “track.csv” file is shown and an MBR image in a last frame (i.frame_end). When the two MBR images are identical, the similarity has a value of 1.0, and when the two MBR images are totally different, the similarity has a value of 0.0. To calculate the similarity between two images, the difference between the two images may be calculated according to the simplest method. The method of the present disclosure is not limited to a specific similarity calculation method.

According to the foregoing method, an ID of which first and last frame images have a similarity of a certain threshold value or less, for example, 0.7 or less, may be split into two different IDs.

According to the present disclosure, to find a frame where automatic splitting will be started, it may be determined which frame has a higher similarity with a last MBR than a similarity with a first MBR by comparing similarities, that is, similarity(j, z_start) with similarity(j, z_end), of all frame MBRs having the same ID with the first MBR and the last MBR.

In this way, a result is finally stored as i.split_point. When i.split_point is 0, the corresponding ID does not require splitting, and when i.split_point is a value other than 0, it is necessary to assign two separate new IDs to an i^{th} ID at a certain frame.

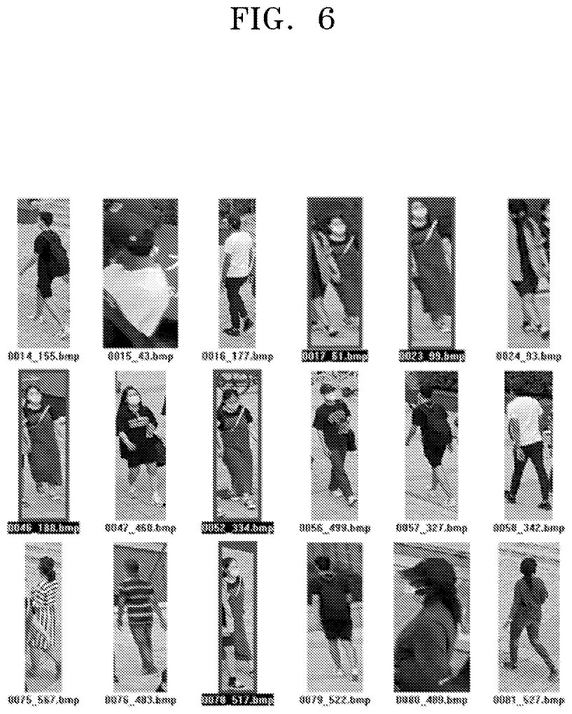

When splitting review is finished, the labeler searches for IDs to be merged and manually merges the IDs. FIG. 6 is a set of images showing examples of a GUI for merging. FIG. 6 shows the GUI of FIG. 4 in further detail for a merging task.

As unique IDs included in a current “split.csv” file, several different IDs are assigned to the same object due to complexity, overlap, and lighting of images, limits of AI technology, and the like. A merging task involves assigning one unified ID to objects which are assigned several different IDs. For example, when the labeler finds and selects all objects which are identical objects present in the screen but assigned different IDs and then selects a “Merge” button (not shown), all the IDs are changed for the smallest one of the selected ID numbers, and then the changed ID is reflected on a “merge.csv” file.

Like the splitting task, the merging task may be automated using an AI technique (111). According to the method of the present disclosure, each representative ID image may be sequentially compared with other representative ID images to check whether the similarity is a threshold value or more, and then an ID of which the similarity is the threshold value or more may be changed for a current ID.

This may be expressed in a C++ algorithm as follows.
n = id count;
i = ID number;
For (i = 1, I < n, i++)
i.flag = i;
For (i = 1, I < n, i++) {
if (i.flag == i)
For (j = i + 1, j < n, j++)
If (similarity(i, j) > Threshold_value) j.flag = i;
}

Here, n is the number of unique IDs, and i is a value between 1 and n.

When an i^{th} ID is the same as an i^{th} “i.flag” value after the merging algorithm is executed, no similar ID is found as a result of comparing the i^{th} ID with other different IDs in the GUI. When the i^{th} ID is not the same as the i^{th} “i.flag” value, a condition that the similarity between different IDs is the threshold value (=0.7) or more is satisfied, and the different IDs are merged to have the same value.

Here, the similarity may be measured using a splitting method or various other methods. Finally, when this task is automatically completed according to AI technology, the results are stored in the “merge.csv” file (112).

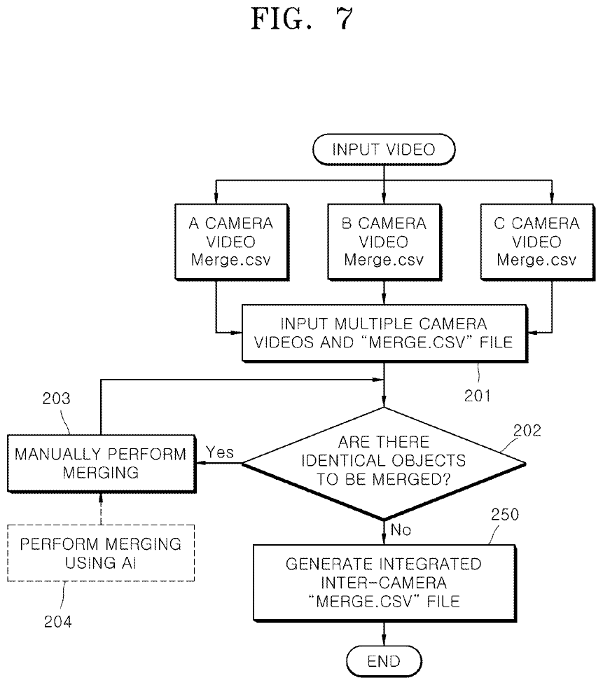

When tagging of objects obtained from one camera is finished, the same objects which are input at different times to other multiple cameras disposed at different locations can be reidentified and tagged as shown in FIG. 7.

When there are a plurality of videos input at different times to cameras A, B, and C which are disposed at different locations and an already processed “merge.csv” file, the multiple camera videos and the “merge.csv” file are input in an integrative manner (201) and displayed in a GUI. Processing results of the operation 201 may be displayed through a GUI for merging as described above with reference to FIG. 6. The processing results are different from those of merging within a single video according to the related art in that camera information representing from which camera each ID number is input is additionally included such as “A(camera name)_0014(ID number)_155(frame number).bmp.”

Subsequent operations 202, 203, 204, and 205 are operations of merging IDs in one camera, which are the same as the operations 109 to 112 shown in FIG. 1. In other words, the tagging method of merging identical IDs in one camera and the method of merging identical IDs in multiple cameras differ only in the form of input but involve the same functional process.

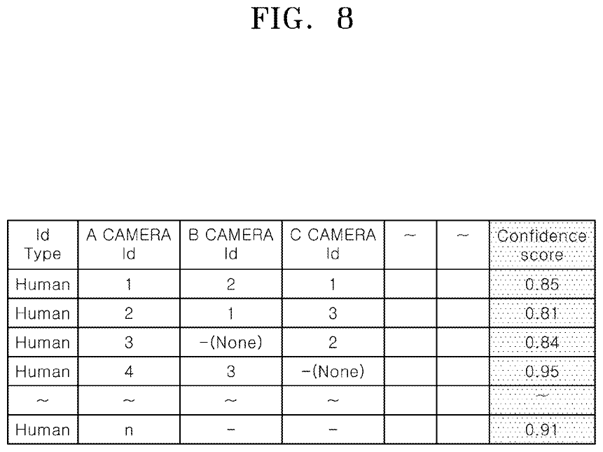

The integrated inter-camera “merge.csv” file may include camera-specific IDs as shown in FIG. 8.

According to the related art, to generate a large amount of training data for object detection, tracking, and reidentification, it is necessary to reduce the total amount of data to be tagged. To this end, in many cases, an object detection and tracking AI technology is applied to a video first, and then a labeler (human) changes or corrects incorrect labeling information obtained through the task while reading the video frame by frame.

This method can reduce time and effort compared to a method of manually labeling objects in all frames one by one without using AI technology in advance. However, when a video is long in length or there are many objects to be labeled in one frame, tagging requires much time and effort, which is an obstacle to generating the large amounts of training data required in the field.

In the method according to the exemplary embodiment of the present disclosure, a human labeler does not check and correct a plurality of objects present in each frame one by one. To develop an object (human) detection, tracking, and identification technology requiring a large amount of training data among AI technologies, training data for detecting and tracking objects (humans) is labeled using an already developed AI technology, and a human labeler can use an object-oriented splitting and merging tool on the data labeled by the AI to finally complete tagging of data for learning detection, tracking, and identification technology.

In addition, the method according to the exemplary embodiment of the present disclosure reduces a tagging time to 1/10 or less compared to the frame-based tagging method according to the related art and saves labeling time and resources by a factor of about 10 or more. Therefore, it is possible to economically collect a large amount of data required for training. Further, when manual splitting and merging for tagging are replaced with an AI technology with excellent performance, the tagging time of the frame-based tagging method according to the related art can be reduced to 1/10 or less again.

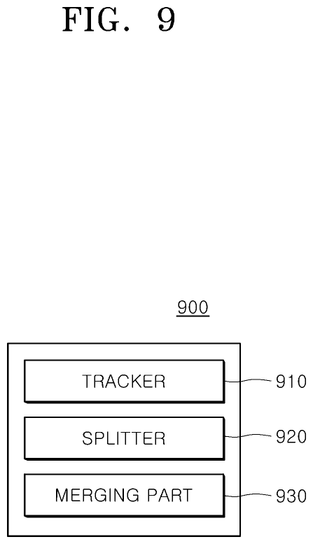

FIG. 9 is a block diagram of a device for tagging training data according to another exemplary embodiment of the present disclosure. FIG. 9 shows a conceptual configuration of a device for performing the method of FIGS. 1 to 8.

Referring to FIG. 9, a device 900 for tagging training data according to the other exemplary embodiment of the present disclosure may include a tracker 910, a splitter 920, and a merging part 930 in addition to basic components required therefor, for example, a memory, a communication part, and the like.

The tracker 910 detects and tracks one or more objects included in a video using AI.

Here, the tracker 910 may track each detected object through a preset object tracking algorithm using the detected object and the input video.

The splitter 920 splits objects one by one when there are objects to be split in a result of tracking the detected objects.

Here, the splitter 920 may calculate a similarity difference between a first image and a last image of each of the detected objects in the result of tracking the detected objects and split the object when the calculated similarity difference is a preset value or less.

When the calculated similarity difference is the preset value or less, the splitter 920 may calculate a similarity between each of other images and the first image and a similarity between each of other images and the last image, find an image having a higher similarity with the last image than a similarity with the first image, and split the object.

The splitter 920 may assign new object IDs to images obtained by splitting the object.

The merging part 930 performs object merging when there are identical objects to be merged among the split objects.

Here, the merging part 930 may calculate a similarity between a representative image of any one of the split objects and a representative image of another one of the split objects and merge the latter object with the former object when the calculated similarity is a preset certain value or more.

The merging part 930 may merge the latter object with the former object by changing an ID of the latter object for an object ID of the former object.

When object merging is performed at each of a plurality of cameras, the merging part 930 may merge objects merged at the plurality of cameras in an integrative manner.

In the device of the present disclosure, the results of object detection, tracking, splitting, and merging may be generated and stored in preset file formats, and the detection result may include type information, (x, y) coordinate information, and width and height information of the one or more detected objects.

Although a description of the device of FIG. 9 is omitted, the entire description of the method illustrated in FIGS. 1 to 8 may apply to the device according to the exemplary embodiment of the present disclosure, which is obvious to those of ordinary skill in the art.

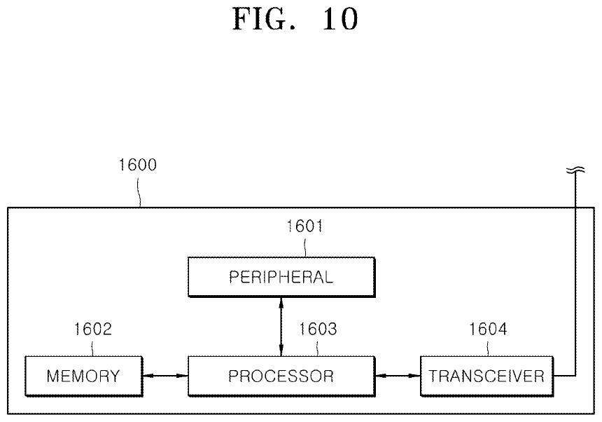

FIG. 10 is a block diagram of a device to which the device for tagging training data according to the other exemplary embodiment of the present disclosure is applied.

For example, the device for tagging training data according to the other exemplary embodiment of the present disclosure may be a device 1600 of FIG. 10. Referring to FIG. 10, the device 1600 may include a memory 1602, a processor 1603, a transceiver 1604, and a peripheral 1601. Further, the device 1600 may include additional other components and is not limited to the embodiment described above. For example, the device 1600 may be a mobile user terminal (e.g., a smartphone, a laptop computer, a wearable device, or the like) or a fixed management device (e.g., a server, a personal computer (PC), or the like).

More specifically, the device 1600 of FIG. 10 may be an exemplary hardware/software architecture such as a training data tagging tool, a data labeling system, or the like. For example, the memory 1602 may be a non-removable memory or a removable memory. Also, for example, the peripheral 1601 may include a display, a Global Positioning System (GPS) device, or other peripheral devices and is not limited to the foregoing embodiment.

For example, the device 1600 described above may include a communication circuit such as the transceiver 1604 and communicate with an external device on the basis of the communication circuit.

For example, the processor 1603 may be at least one of a general processor, a digital signal processor (DSP), a DSP core, a controller, a microcontroller, application-specific integrated circuits (ASICs), field programmable gate array (FPGA) circuits, different types of integrated circuits (ICs), and one or more microprocessors related to a state machine. In other words, the processor 1603 may be a hardware/software component for controlling the device 1600 described above. Also, the processor 1603 may modularize and perform functions of the tracker 910, the splitter 920, and the merging part 930 of FIG. 9 described above.

Here, the processor 1603 may execute computer-executable instructions stored in the memory 1602 to perform various necessary functions of the device for tagging training data. For example, the processor 1603 may control at least one of signal coding, data processing, power control, input/output processing, and communication operations. Also, the processor 1603 may control a physical layer, a media access control (MAC) layer, and an application layer. For example, the processor 1603 may perform an authentication and security procedure in an access layer, the application layer, and/or the like and is not limited to the foregoing embodiment.

For example, the processor 1603 may communicate with other devices through the transceiver 1604. For example, the processor 1603 may control the device for tagging training data by executing computer-executable instructions so that the device for tagging training data may communicate with other devices through a network. In other words, communication performed in the present disclosure may be controlled. For example, the transceiver 1604 may transmit a radio frequency (RF) signal through an antenna and transmit a signal on the basis of various communication networks.

As examples of antenna technology, multiple-input multiple-output (MIMO) technology, beamforming, and the like may be employed, and the antenna technology is not limited to the foregoing embodiment. Also, signals transmitted or received through the transceiver 1604 may be modulated or demodulated and then controlled by the processor 1603, and processing of signals is not limited to the foregoing embodiment.

According to the present disclosure, it is possible to provide a training data tagging device and method for efficiently generating a large amount of training data required for deep learning for detecting, tracking, and reidentifying various objects present in a camera.

Effects which can be achieved from the present disclosure are not limited to that described above, and other effects which have not been described will be clearly understood by those of ordinary skill in the art from the above description.

Although the exemplary methods of the present disclosure are represented by a series of operations for clarity of description, they are not intended to limit the order in which the operations are performed, and if necessary, the operations may be performed simultaneously or in a different order. To implement a method according to the present disclosure, illustrative operations may include an additional operation or exclude some operations while including the remaining operations. Alternatively, some operations may be excluded while additional operations are included.

Various embodiments of the present disclosure are not intended to be all-inclusive and are intended to illustrate representative aspects of the present disclosure. Features described in the various embodiments may be applied independently or in a combination of two or more thereof.

In addition, various embodiments of the present disclosure may be implemented by hardware, firmware, software, or a combination thereof. In the case of hardware implementation, one or more ASICs, DSPs, digital signal processing devices (DSPDs), programmable logic devices (PLDs), FPGAs, general processors, controllers, microcontrollers, microprocessors, etc. may be used for implementation.

The scope of the present disclosure includes software or machine-executable instructions (e.g., an operating system (OS), an application, firmware, a program, etc.) that enable operations according to methods of various embodiments to be performed on a device or computer, and a non-transitory computer-readable medium in which such software or instructions are stored and executable on a device or computer.

What is claimed is:

1. A method of tagging training data, the method comprising:
detecting and tracking one or more objects included in a video using artificial intelligence (AI);
when there is an object to be split in a result of tracking the detected objects, splitting the object in object units; and
when there are identical objects to be merged among split objects, merging the objects.

2. The method of claim 1, wherein the splitting of the object comprises calculating a similarity difference between a first image and a last image of each of the detected objects in the result of tracking the detected objects and splitting the corresponding object when the calculated similarity difference is a preset value or less.

3. The method of claim 2, wherein the splitting of the object comprises, when the calculated similarity difference is the preset value or less, calculating a similarity between each of remaining images and the first image and a similarity between each of the remaining images and the last image, finding an image having a higher similarity with the last image than a similarity with the first image, and splitting the object.

4. The method of claim 3, wherein the splitting of the object comprises assigning new object identities (IDs) to images obtained by splitting the object.

5. The method of claim 1, wherein the merging of the objects comprises calculating a similarity between a representative image of any one of the split objects and a representative image of another one of the split objects and merging the latter object with the former object when the calculated similarity is a preset certain value or more.

6. The method of claim 5, wherein the merging of the objects comprises merging the latter object with the former object by changing an identity (ID) of the latter object to an object ID of the former object.

7. The method of claim 1, wherein the merging of the objects comprises, when object merging is performed at each of a plurality of cameras, merging objects merged at the plurality of cameras in an integrative manner.

8. The method of claim 1, wherein results of the detecting, the tracking, the splitting, and the merging are generated and stored in preset file formats, and
the result of detecting includes type information, (x, y) coordinate information, and width and height information of the one or more detected objects.

9. A device for tagging training data, the device comprising:
a tracker configured to detect and track one or more objects included in a video using artificial intelligence (AI);
a splitter configured to perform object splitting in object units when there is an object to be split in a result of tracking the detected objects; and
a merging part configured to perform object merging when there are identical objects to be merged among split objects.

10. The device of claim 9, wherein the splitter calculates a similarity difference between a first image and a last image of each of the detected objects in the result of tracking the detected objects and splits the corresponding object when the calculated similarity difference is a preset value or less.

11. The device of claim 10, wherein, when the calculated similarity difference is the preset value or less, the splitter calculates a similarity between each of remaining images and the first image and a similarity between each of the remaining images and the last image, finds an image having a higher similarity with the last image than a similarity with the first image, and splits the object.

12. The device of claim 11, wherein the splitter assigns new object identities (IDs) to images obtained by splitting the object.

13. The device of claim 9, wherein the merging part calculates a similarity between a representative image of any one of the split objects and a representative image of another one of the split objects and merges the latter object with the former object when the calculated similarity is a preset certain value or more.

14. The device of claim 13, wherein the merging part merges the latter object with the former object by changing an identity (ID) of the latter object to an object ID of the former object.

15. The device of claim 9, wherein, when object merging is performed at each of a plurality of cameras, the merging part merges objects merged at the plurality of cameras in an integrative manner.

16. The device of claim 9, wherein results of the detecting, the tracking, the splitting, and the merging are generated and stored in preset file formats, and
the result of detecting includes type information, (x, y) coordinate information, and width and height information of the one or more detected objects.
